(19) United States
(12) Patent Application Publication
(10) Pub. No.: US 2021/0302190 A1
(43) Pub. Date: Sep. 30, 2021

(54) INFORMATION PROVISION SYSTEM, INFORMATION PROVISION DEVICE, AND COMPUTER PROGRAM

(71) Applicant: AISIN AW CO., LTD., Anjo-shi, Aichi-ken (JP)

(72) Inventors: Naoto MIURA, Okazaki, Aichi (JP); Hajime MORIKAWA, Nagoya-shi, Aichi-ken (JP); Hideki KASEZAWA, Okazaki, Aichi (JP); Koichi IWATSUKI, Okazaki, Aichi (JP); Motohiro NAKAMURA, Okazaki, Aichi (JP)

(73) Assignee: AISIN AW CO., LTD., Anjo-shi, Aichi-ken (JP)

(21) Appl. No.: 17/266,225

(22) PCT Filed: Oct. 4, 2019
(86) PCT No.: PCT/JP2019/039374

§ 371 Date: Feb. 5, 2021

(30) Foreign Application Priority Data
Oct. 4, 2018 (JP) 2018-188822
Oct. 4, 2019 (JP) 2019-183747

(51) Int. Cl. G01C 21/36

(52) U.S. Cl. CPC G01C 21/3611; G01C 21/3608; G01C 21/3617

(57) ABSTRACT

There are provided an information provision system and an information provision device that can provide information that a user wants even when user's input content is lacking or unclear. Specifically, it is determined whether requirements which are items required to identify information requested by a user can be identified from text inputted by the user, by analyzing the text inputted by the user. When the requirements cannot be identified from the text inputted by the user, the requirements are complemented using user information stored in a user information DB 13. Based on the complemented requirements, information responding to a user request is provided.

### CROSS REFERENCE TO RELATED APPLICATIONS

This application is a National Stage of International Application No. PCT/JP2019/039374 filed on Oct. 4, 2019, claiming the benefit of priority from Japanese Patent Application No. 2018-188822 filed on Oct. 4, 2018 and Japanese Patent Application No. 2019-183747 filed on Oct. 4, 2019, the entire contents of which are incorporated herein by reference.

### TECHNICAL FIELD

The present disclosure relates to an information provision system, an information provision device, and a computer program that provide information selected based on user input.

### BACKGROUND ART

Conventionally, various types of information terminals such as navigation devices for in-vehicle use, mobile phones, smartphones, tablet terminals, and personal computers (hereinafter, referred to as navigation devices, etc.) can store information about map images and locations in various types of storage devices or obtain such information by downloading the information from a server, etc., and provide the information to users. In addition, as information about locations, for example, information about the names, locations, business hours, usage fees, etc., of stores, public facilities, etc., can be provided. Furthermore, besides information about map images and locations, various information can also be provided.

In addition, in recent years, provision of information has also been performed in such a manner that a user utters conditions for information that he/she wants, etc., by speech, and a system side recognizes the speech and extracts and provides information corresponding to the conditions. However, information retrieval using speech has a problem that the system side has difficulty in accurately grasping conditions for information that the user wants, due to the lack, unclearness, etc., of user's utterance content. In addition, the same also happens when the user inputs conditions for information that he/she wants, etc., by text by performing a character input operation using a keyboard, a touch panel, etc., and there is a problem that the system side has difficulty in accurately grasping conditions for information that the user wants, due to the lack, unclearness, etc., of user's input content. Hence, for example, JP 2001-296888 A discloses a technique in which in a system that provides location information based on user's utterance content, when there are a plurality of locations corresponding to user's utterance content and the system cannot identify which piece of information about a location is requested by the user, the system provides all corresponding locations in list form.

### CITATIONS LIST

### Patent Literature

Patent Literature 1: JP 2001-296888 A (pp. 4-5 and FIG. 3)

### SUMMARY OF THE DISCLOSURE

### Technical Problems

However, in the technique described in the above-described Patent Literature 1, multiple pieces of information other than information that the user actually wants are also provided, and thus, there has been a problem that the user needs to find a piece of information that he/she wants from among the provided multiple pieces of information.

The aspects of the present disclosure are made to solve the above-described conventional problem, and provide an information provision system, an information provision device, and a computer program that complement user's input content based on user information, by which it becomes possible to provide information that a user wants even when the user's input content is lacking or unclear.

### Solutions to Problems

To provide the above-described information provision system, information provision device, and computer program, an information provision system according to the present invention includes: user information obtaining means for obtaining user information about a user; requirement determining means for determining whether requirements can be identified from text inputted by a user, by analyzing text inputted by a user, the requirements being items required to identify information requested by a user; complementing means for complementing the requirements using the user information when the requirements cannot be identified from text inputted by a user; and information providing means for providing information responding to a user request, based on the complemented requirements.

Note that the “text inputted by the user” corresponds, for example, to text inputted by recognizing speech uttered by the user and text inputted by the user selecting or handwriting characters which are objects to be inputted, using a keyboard, a touch panel, etc.

In addition, the “text” corresponds to language expression that expresses user's thoughts or feelings, and may include only one sentence or may include a plurality of sentences. Furthermore, a sentence basically includes a plurality of phrases, but may include only one phrase.

In addition, an information provision device according to the present invention includes: user information obtaining means for obtaining user information about a user; requirement determining means for determining whether requirements can be identified from text inputted by a user, by analyzing text inputted by a user, the requirements being items required to identify information requested by a user; complementing means for complementing the requirements using the user information when the requirements cannot be identified from text inputted by a user; and information providing means for providing information responding to a user request, based on the complemented requirements.

In addition, a computer program according to the present disclosure is a computer program that provides a user with information responding to his/her request. Specifically, the computer program causes a computer to function as: user information obtaining means for obtaining user information about a user; requirement determining means for determining whether requirements can be identified from text inputted by a user, by analyzing text inputted by a user, the requirements being items required to identify information requested by a user; complementing means for complementing the requirements using the user information when the requirements cannot be identified from text inputted by a user; and information providing means for providing information responding to a user request, based on the complemented requirements.

### Advantageous Effects of Various Aspects of the Disclosure

According to the information provision system, information provision device, and computer program according to the present invention that have the above-described configurations, when requirements which are items required to identify information requested by a user cannot be identified from text inputted by the user, the requirements are complemented based on user information, by which it becomes possible to provide information that the user wants even when user's input content is lacking or unclear.

### BRIEF DESCRIPTION OF DRAWINGS

FIG. 1 is a schematic configuration diagram showing an information provision system according to the present embodiment.

FIG. 2 is a block diagram showing a configuration of the information provision system according to the present embodiment.

FIG. 3 is a diagram showing an example of information stored in a user information DB.

FIG. 4 is a block diagram schematically showing a control system of an information terminal according to the present embodiment.

FIG. 5 is a flowchart of a DB creation processing program according to the present embodiment.

FIG. 6 is a diagram showing an example of statistical results of a user's activity history.

FIG. 7 is a flowchart of an information provision processing program according to the present embodiment.

FIG. 8 is a diagram showing an example of an information provision method.

FIG. 9 is a diagram describing an exemplary analysis of user's utterance content.

FIG. 10 is a diagram showing requirements set in a case of providing information about a recommended route to a destination.

FIG. 11 is a diagram describing an exemplary analysis of user's utterance content.

### DESCRIPTION OF EMBODIMENTS

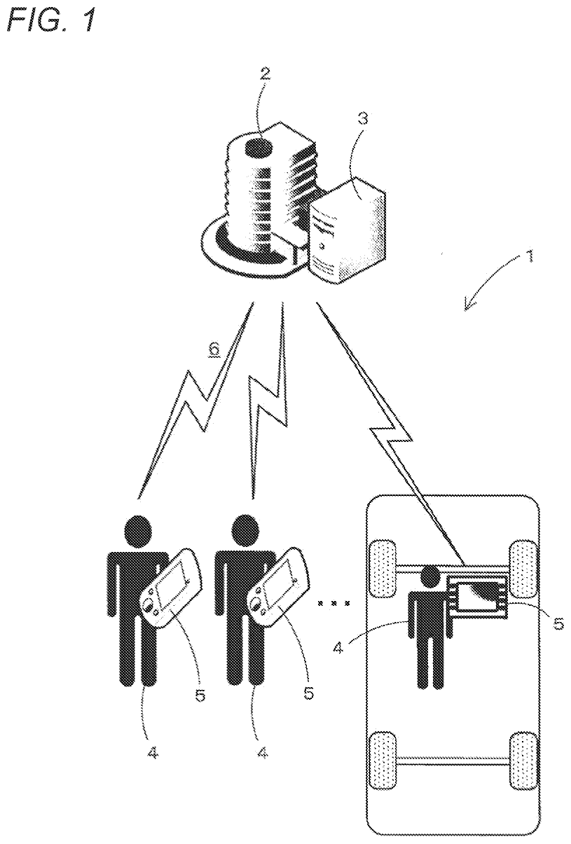

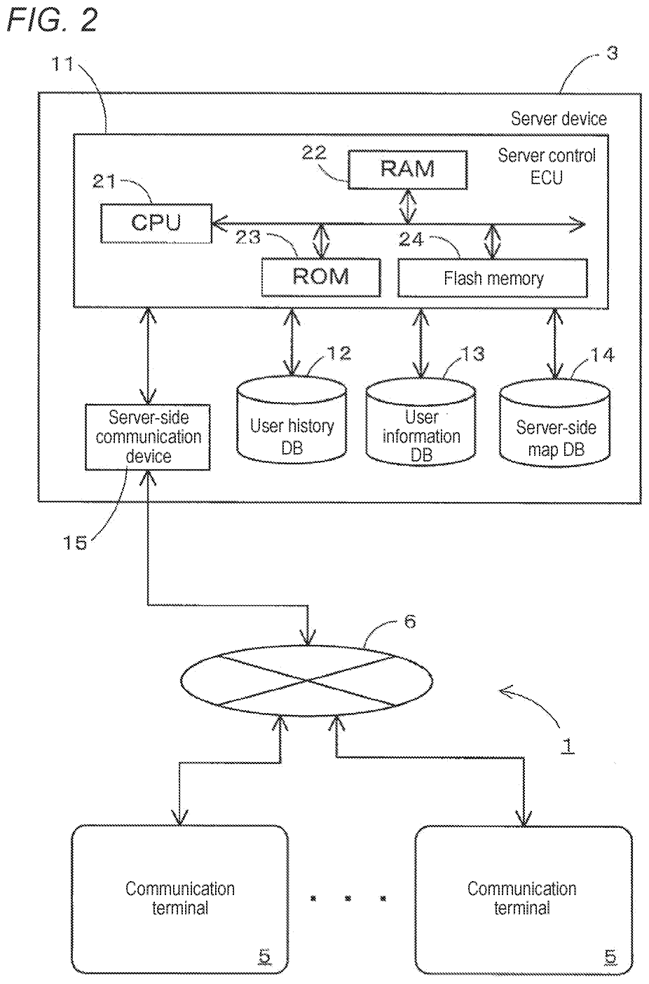

An information provision system according to the present invention will be described in detail below with reference to the drawings and based on one embodiment that embodies the information provision system. First, a schematic configuration of an information provision system 1 according to the present embodiment will be described using FIGS. 1 and 2. FIG. 1 is a schematic configuration diagram showing the information provision system 1 according to the present embodiment. FIG. 2 is a block diagram showing a configuration of the information provision system 1 according to the present embodiment.

As shown in FIG. 1, the information provision system 1 according to the present embodiment basically includes a server device (information provision device) 3 provided in an information provision center 2; and information terminals 5 carried by users 4. In addition, the server device 3 and the information terminals 5 are configured such that they can perform transmission and reception of electronic data with each other through a communication network 6. Note that the information terminals 5 include, for example, mobile phones, smartphones, tablet terminals, personal computers, and navigation devices. Note also that the users 4 may be in a state of being in vehicles or may be in a state of being not in vehicles.

Here, the server device 3 provided in the information provision center 2 is an information delivery server that has a DB having stored therein various types of information that can be provided to the users 4, and extracts corresponding information in response to a request from a user 4 and delivers (provides) the corresponding information to the user 4. In the present embodiment, objects to be delivered are, for example, information about a recommended route to a destination specified by a user 4, location information about locations (facilities) across the country, and traffic information (whether there is congestion, an accident, or construction work, etc.) on each road across the country. Note that upon delivering the above-described information, the server device 3 according to the present embodiment identifies information requested by a user 4, based on speech uttered by the user 4, using a speech recognition device.

In addition, upon providing information about a recommended route, the server device 3 also performs a process of searching for a recommended route in response to a request from an information terminal 5. Specifically, information required for a route search, such as a destination and means of transportation, is obtained based on text inputted by a user 4. Thereafter, the server device 3 performs a route search using map information provided in the server device 3, and identifies a recommended route from a point of departure to the destination. Then, information about the identified recommended route is transmitted to the information terminal 5 which is a request source, by which the information is provided to the user. Note that the input of text can be performed by, for example, speech recognition, a touch panel operation, or a keyboard operation, but in the following description, particularly, a case in which the input of text is performed by recognizing speech uttered by the user by speech recognition will be described as an example. Namely, content uttered by the user becomes text to be inputted. In addition, in the following description, the term “text” corresponds to language expression that expresses user's thoughts or feelings, and may include only one sentence or may include a plurality of sentences. Furthermore, a sentence basically includes a plurality of phrases, but may include only one phrase.

On the other hand, when the server device 3 cannot identify requirements which are items required to identify information requested by the user from text uttered by the user, due to the lack or unclearness of utterance content of the user that requests information, the server device 3 also complements the requirements based on user information as will be described later. The user information corresponds, for example, to information that identifies a user's activity tendency for each state.

Meanwhile, the information terminals 5 are carried by the users 4, and information terminals having navigation functions are used. The information terminals 5 correspond, for example, to mobile phones, smartphones, tablet terminals, personal computers, and navigation devices.

Here, the navigation functions correspond to a function of displaying route information that identifies a route searched by the above-described server device 3, a function of displaying an image of a map around a current location of a user 4 based on map data obtained from the server or stored in a memory, a function of displaying the current location of the user 4 in the displayed image of a map, and a function of providing travel guidance along a set guidance route. Note that the information terminals 5 do not need to have all of the above-described navigation functions, and as long as the information terminals 5 have at least the function of displaying route information, the invention of the present application can be formed.

In addition, the communication network 6 includes multiple base stations disposed all over the country and telecommunications companies that manage and control the base stations, and is formed by connecting the base stations to the telecommunications companies by wire (optical fiber, ISDN, etc.) or wirelessly. Here, each base station includes a transceiver and an antenna that perform communication with the information terminals 5. While the base station performs radio communication with a telecommunications company, the base station serves as an end of the communication network 6 and plays a role in relaying communication of information terminals 5 present in an area (cell) in which radio waves from the base station reach, to the server device 3.

Next, a configuration of the server device 3 in the information provision system 1 will be described in more detail using FIG. 2. The server device 3 includes, as shown in FIG. 2, a server control ECU 11; a user history DB 12, a user information DB 13, and a server-side map DB 14 that are connected to the server control ECU 11 and serve as information recording means; and a server-side communication device 15.

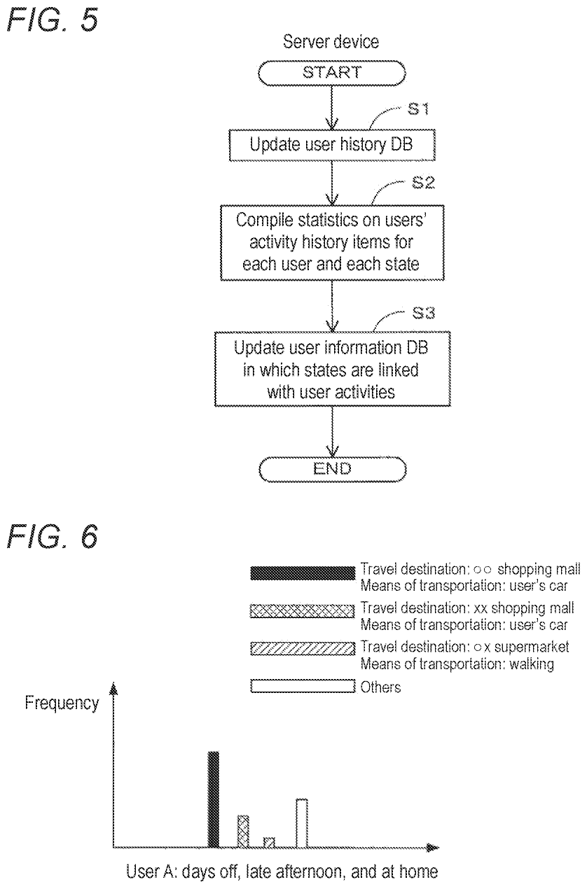

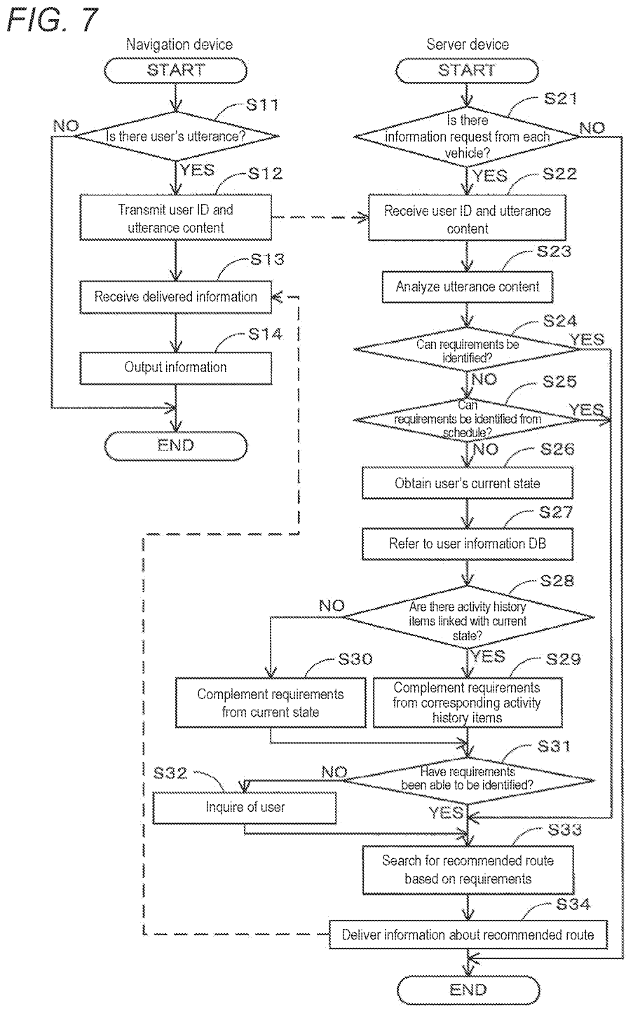

The server control ECU 11 (electronic control unit) is an electronic control unit that performs overall control of the server device 3, and includes a CPU 21 serving as a computing device and a control device; and internal storage devices such as a RAM 22 used as a working memory when the CPU 21 performs various types of arithmetic processing, a ROM 23 having recorded therein a DB creation processing program (FIG. 5) and an information provision processing program (see FIG. 7) which will be described later, etc., in addition to a program for control, and a flash memory 24 that stores a program read from the ROM 23. Note that the server control ECU 11 includes various types of means serving as processing algorithms with an ECU of an information terminal 5 which will be described later. For example, user information obtaining means obtains user information about a user. Requirement determining means determines whether requirements which are items required to identify information requested by the user can be identified from text inputted by the user, by analyzing the text inputted by the user. Complementing means complements the requirements using user information when the requirements cannot be identified from the text inputted by the user. Information providing means provides information responding to a user request, based on the complemented requirements.

In addition, the user history DB 12 is storage means for collecting and storing past activity histories of the users 4. Specifically, users' travel histories, users' destination setting histories, means of transportation used by the users to travel, states in which the users have traveled (travel start locations, hours, etc.), and the content of users' schedules registered in the past or at the present time are collected from the information terminals 5, and sorted by user and stored. Note that the user history DB 12 is periodically updated as appropriate, based on information transmitted from the information terminals 5.

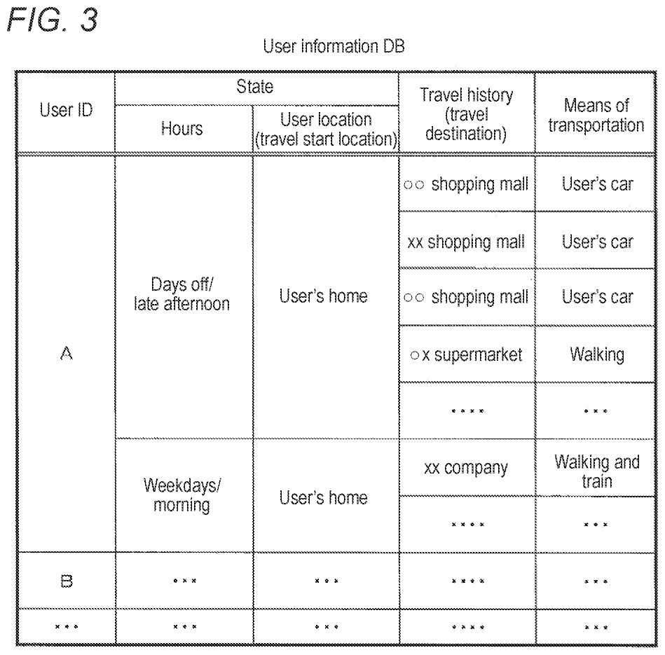

Meanwhile, the user information DB 13 is a database which is created by compiling statistics on pieces of information stored in the user history DB 12, and in which a user's past activity history item is linked with a state in which an activity in the activity history item is performed (e.g., a user location and hours). Particularly, when a plurality of user activities are performed in the same state, each of history items of the plurality of user activities is linked. As a result, the user information DB 13 results in a database showing, for each state, activities that tend to be performed by a user, i.e., user's activity characteristics. In addition, the user information DB 13 stores, as a user's activity history item, a “travel destination to which the user has traveled” and “what means of transportation has been used to travel to the travel destination”. For example, FIG. 3 is a diagram showing an example of data stored in the user information DB 13.

As shown in FIG. 3, the user information DB 13 stores, for each user, a user's past activity history item and a state in which an activity in the activity history item is performed, such that they are linked with each other. For example, the user information DB 13 shows that in a state in which a user A stays home in the late afternoon on his/her day off in the past, the user A has traveled to a ‘∘∘ shopping mall’ and a ‘xx shopping mall’ by his/her car and traveled to a ‘∘x supermarket’ by foot. The user information DB 13 particularly shows that the user A has traveled to the ‘∘∘ shopping mall’ a plurality of times. Note that in the example shown in FIG. 3, a state is identified by a user location (a travel start location), weekdays or days off, and hours (e.g., morning, daytime, and evening), but may be identified by other elements. For example, days or seasons may be used.

The created user information DB 13 shows association between states and user activities (activities that tend to be performed by a user for each state). Therefore, when the server device 3 cannot identify requirements which are items required to identify information requested by the user from text uttered by the user, due to the lack or unclearness of utterance content of the user that requests information, the server device 3 can predict information that the user wants in a current state based on the user information DB 13, and complement the requirements based on results of the prediction. Then, information is provided based on the complemented requirements. Details will be described later.

Meanwhile, the server-side map DB 14 is storage means for storing server-side map information which is the latest version of map information registered based on input data from an external source or input operations. Here, the server-side map information includes road networks and various types of information that are required for a route search, route guidance, and map display. The server-side map information includes, for example, network data including nodes and links that represent road networks, link data about roads (links), node data about node points, intersection data about each intersection, location data about locations such as facilities, map display data for displaying a map, search data for searching for a route, and retrieval data for retrieving a location. Furthermore, there are also stored various types of information for searching for a route that uses means of transportation such as a railroad, a bus, a ship, and an airplane (railroad tracks, railroad timetables, bus stops, bus routes, bus timetables, ship routes, ship timetables, air routes, airline timetables, etc.). Note, however, that these pieces of information may be obtained from an external server.

Meanwhile, the server-side communication device 15 is a communication device for performing communication with the information terminals 5 through the communication network 6. In addition, it is also possible to receive traffic information including pieces of information such as congestion information, regulation information, and traffic accident information, which is transmitted from an Internet network or a traffic information center, e.g., a VICS (registered trademark: Vehicle Information and Communication System) center, besides the information terminals 5.

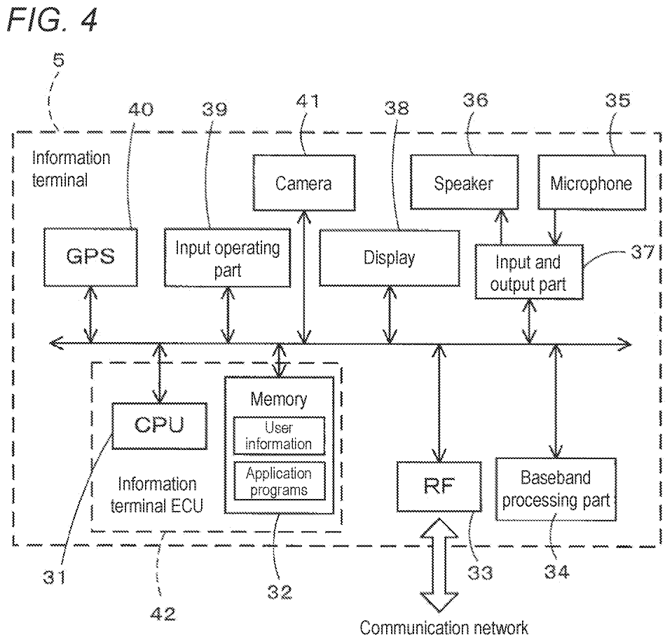

Next, a schematic configuration of an information terminal 5 will be described using FIG. 4. FIG. 4 is a block diagram schematically showing a control system of an information terminal 5 according to the present embodiment. Note that in the following, particularly, a case in which the information terminal 5 is a smartphone will be described as an example.

As shown in FIG. 4, the information terminal 5 is configured such that a CPU 31, a memory 32 having stored therein, for example, user information (a user ID, a name, etc.) about a user 4 carrying the information terminal 5, a transmission and reception circuit part (RF) 33 that performs transmission and reception of signals with the base stations in the communication network 6, a baseband processing part 34 that converts a radio frequency (RF) signal received by the transmission and reception circuit part 33 into a baseband signal and converts a baseband signal into an RF signal, an input and output part 37 which is an interface for a microphone 35, a speaker 36, etc., a display 38 including a liquid crystal display panel, etc., an input operating part 39 including a touch panel, hard buttons, etc., a GPS 40, and a camera 41 are connected to a data bus BUS.

Here, the CPU 31 included in the information terminal 5 is control means for the information terminal 5 that performs various operations in accordance with an operating program stored in the memory 32, and forms an information terminal ECU 42 with the memory 32. In addition, various types of processing content of the information terminal ECU 42 are displayed on the display 38 as necessary.

In addition, the memory 32 is a storage medium having stored therein, for example, user information (a user ID, a name, etc.) about the user 4 carrying the information terminal 5. In addition, the memory 32 also stores various types of application programs including a schedule management app and a navigation app, in addition to an information provision processing program (FIG. 7) which will be described later. Furthermore, in the present embodiment, the memory 32 also stores a past activity history of the user carrying the information terminal 5. The past activity history corresponds, for example, to a user's travel history (GPS detection history), a user's destination setting history by the navigation functions, means of transportation used by the user to travel, states in which the user has traveled (travel start locations, hours, etc.), and the content of a registered user's schedule. In addition, the memory 32 may store map information. If map information is stored in the memory 32, then a process related to a route search can be performed by the information terminal 5 instead of the server device 3. In addition, the memory 32 may be composed of a hard disk, a memory card, etc.

In addition, the information terminal 5 also has an application for performing speech recognition installed thereon, by which content of speech recorded by the microphone 35 can be analyzed. The information terminal 5 according to the present embodiment recognizes speech uttered by the user and transmits content of the recognized speech to the server device 3. Note, however, that speech recognition may be performed on a server device 3 side. In that case, recorded speech data is transmitted to the server device 3.

In addition, the display 38 is disposed on one surface of a casing, and a liquid crystal display, an organic EL display, or the like, is used. There are displayed various types of information such as a top screen for executing various types of applications installed on the information terminal 5, a screen related to an executed application (an Internet screen, an email screen, etc.), images, and moving images. In addition, when a route search is performed, route information that identifies a searched route is also displayed.

In addition, the input operating part 39 includes a touch panel provided on the front of the display 38, hard buttons disposed on the casing, etc. The information terminal ECU 42 performs control to perform various types of corresponding operations, based on an electrical signal outputted by, for example, pressing the touch panel or the hard buttons. Note that the input operating part 39 can also include, for example, various types of keys such as number/character input keys, cursor keys that move a cursor for selecting displayed content, and an OK key that confirms a selection.

In addition, the GPS 40 can detect the current location and current date and time of the information terminal 5 (i.e., the user 4) by receiving radio waves generated by artificial satellites. In addition, the configuration may be such that besides the GPS 40, another device (e.g., a gyro sensor) for detecting the current location and bearing of the information terminal 5 is provided.

In addition, the camera 41 is a small imaging device including, for example, a camera using a solid-state imaging element such as a CCD, and is included on a back side of the information terminal 5. By the user operating the input operating part 39 with a dedicated application program being activated, an image of an area around the camera 41 can be captured. Note that the captured image which is captured by the camera 41 is stored in the memory 32.

Next, a DB creation processing program which is executed by the CPU 21 in the server device 3 included in the information provision system 1 according to the present embodiment that has the above-described configuration will be described based on FIG. 5. FIG. 5 is a flowchart of the DB creation processing program according to the present embodiment. Here, the DB creation processing program is a program that is executed at a predetermined time interval (e.g., 24-hour interval) and creates a DB in which, for each user, a user's past activity history item is linked with a state in which an activity in the activity history item is performed, by compiling statistics on user's past activity history items. Note that programs shown in flowcharts in the following FIGS. 5 and 7 are stored in the memory 32 included in the information terminal 5, the RAM 22 or ROM 23 included in the server device 3, or the like, and executed by the CPU 31 or the CPU 21.

First, in the DB creation processing program, at step (hereinafter, abbreviated as S) 1, the CPU 21 updates the user history DB 12 based on information collected from the information terminals 5. The user history DB 12 is, as described above, a database that stores users' past activity histories. Specifically, users' travel histories (e.g., GPS detection histories), users' destination setting histories, means of transportation used by the users to travel, states in which the users have traveled (travel start locations, hours, etc.), and the content of users' schedules registered in the past or at the present time are collected from the information terminals 5, and sorted by user and stored in the user history DB 12. Note that the content of users' schedules may be obtained from an external server that manages schedules.

Note that the user history DB 12 does not need to store all of the users' travel histories, users' destination setting histories, means of transportation used by the users to travel, and the content of users' schedules, and may store, for example, only users' travel histories and means of transportation used by the users to travel. Alternatively, only the content of users' schedules may be stored. Any information may be stored as long as the information can identify at least travel destinations upon users' travel in the past and what means of transportation have been used to travel to the travel destinations.

Then, at S2, the CPU 21 compiles statistics on information stored in the user history DB 12 updated at the above-described 51, sorts the information by user and state, and compiles statistics on users' activity history items. Note that a state is divided into, for example, a user location (a travel start location), weekdays or days off, and hours (e.g., morning, daytime, and evening). Note also that a user activity identifies a “travel destination to which the user has traveled” and “what means of transportation has been used to travel to the travel destination”.

For example, an example shown in FIG. 6 is a diagram showing statistical results of activities at home in the late afternoon (3-7 p.m.) on days off in an activity history of a predetermined user A stored in the user history DB 12. In the example shown in FIG. 6, it can be seen that in a state in which the user A stays home in the late afternoon in the past, the user A has travels to the ‘∘∘ shopping mall’ and the ‘xx shopping mall’ by his/her car with high frequency. Namely, it shows that the user A has a tendency to travel to the ‘∘∘ shopping mall’ and the ‘xx shopping mall’ by his/her car in a state in which he/she stays home in the late afternoon on days off.

Thereafter, at S3, the CPU 21 updates the user information DB 13 using statistical results obtained at the above-described S2. Specifically, as shown in FIG. 3, information is sorted by user and state and all history items of activities performed in a corresponding state by a corresponding user are stored so as to be linked. When the same activity is performed a plurality of times, a plurality of activity history items with the same content are linked. Note, however, that information that identifies the number of times the activity is performed may be added.

A user information DB 13 generated as a result shows, as shown in FIG. 3, association between states and user activities (activities that tend to be performed by the users for each state). Therefore, as will be describe later, when the server device 3 cannot identify requirements which are items required to identify information requested by a user from text uttered by the user, due to the lack or unclearness of utterance content of the user that requests information, the server device 3 can predict information that the user wants in a current state based on the user information DB 13, and complement the requirements based on results of the prediction.

Note that although, in the present embodiment, information is sorted by user and state and all history items of activities performed in a corresponding state by a corresponding user are stored in the user information DB 13 so as to be linked, only a history item of an activity that is repeatedly performed a predetermined number of times (e.g., three times) or more may be stored so as to be linked.

Next, an information provision processing program executed by the server device 3 and the information terminals 5 which are included in the information provision system 1 according to the present embodiment will be described based on FIG. 7. FIG. 7 is a flowchart of the information provision processing program according to the present embodiment. Here, the information provision processing program is a program that is executed after a navigation app is activated on an information terminal 5, and provides various types of information in response to a user request. Note that the following describes particularly an example of providing information about a recommended route to a destination, but it is, of course, possible that an object to be provided is other information.

First, an information provision processing program executed by the information terminal 5 will be described.

At S11, the CPU 31 determines whether there has been an utterance of a user that wants provision of information, by analyzing speech data collected by the microphone 35, using a speech recognition app. Note that since information that is an object to be provided in the present embodiment is information about a recommended route to a destination, the utterance of a user that wants provision of information is content such as “want to go to . . . ” or “want to know how to get to . . . ”. In addition, the utterance of the user also includes words that specify search conditions such as a point of departure, a destination, means of transportation, a departure time, a desired arrival time, a stop-by location, a stop-by time, and a stop-by time period. Note, however, that there is no need to include all of the above-described items.

Then, if it is determined that there has been an utterance of a user that wants provision of information (S11: YES), processing transitions to S12. On the other hand, if it is determined that there is no utterance of a user that wants provision of information (S11: NO), the information provision processing program ends without providing information.

At S12, the CPU 31 transmits an information request instruction instructing the server device 3 for an information request. The information request instruction includes a user ID that identifies the user and content of the user's utterance (e.g., text data) accepted at the above-described S11. Thereafter, as will be described later, the server device 3 having received the information request instruction from the information terminal 5 extracts and delivers information that the user wants (S22 to S34).

Note that speech recognition may be performed on the server device 3 side. In that case, it is also possible to transmit, at the above-described S12, the collected speech data instead of the utterance content, to the server device 3.

Subsequently, at S13, the CPU 31 receives information delivered from the server device 3 in response to the transmission of an information request instruction signal. The information received at the above-described S13 is information that corresponds to the content of the user's utterance accepted at the above-described S11 and that the user wants. The information is identified by processes at S22 to S34 which will be described later.

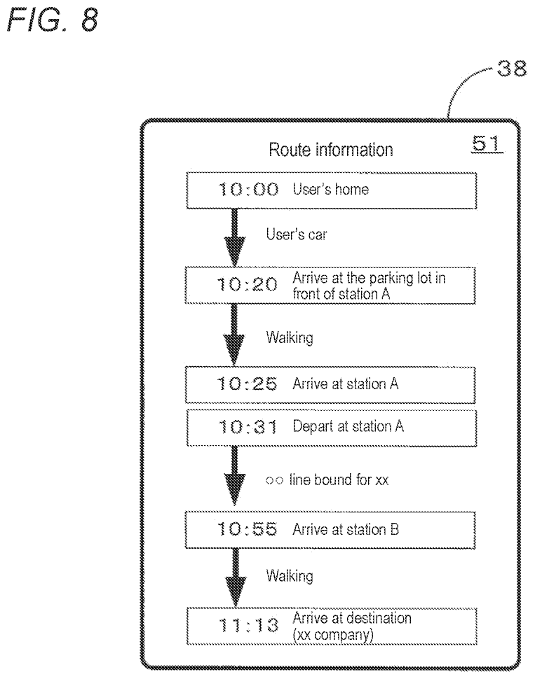

Thereafter, at S14, the CPU 31 outputs the information received at the above-described S13, using the display 38 or the speaker 36. In a case of providing information about a recommended route to a destination, information about a recommended route from a point of departure to a destination that is searched by the server device 3 in response to a route search request is outputted. Here, FIG. 8 is a diagram showing an example of information about a recommended route displayed on the display 38.

As shown in FIG. 8, a route guidance screen 51 chronologically displays a route from a point of departure to a destination in sequence, together with means of transportation and expected arrival time, as route information that identifies a recommended route. The user can grasp appropriate means of transportation and an appropriate way to travel to the destination by referring to the route guidance screen 51. In addition, an image in which the recommended route is shown on a map may also be displayed. Note that the user can also request a route search again by changing search conditions after visually checking the displayed route information of the recommended route.

Next, an information provision processing program executed by the server device 3 will be described.

First, at S21, the CPU 21 determines whether there is transmission of an information request instruction instructing for an information request from an information terminal 5.

Then, if it is determined that there is transmission of an information request instruction (S21: YES), the information request instruction transmitted is received (S22). Note that an information request instruction signal includes a user ID that identifies a user having requested information and user's utterance content (e.g., text data).

On the other hand, if it is determined that there is no transmission of an information request instruction (S21: NO), the information provision processing program ends.

At S23, the CPU 21 analyzes particularly the user's utterance content in the information request instruction received at the above-described S22. Then, at S24, the CPU 21 determines whether items required to identify information requested by the user (hereinafter, referred to as requirements) can be identified from text uttered by the user, as a result of the analysis at the above-described S23.

A process of analyzing the utterance content at the above-described S23 will be described in more detail below.

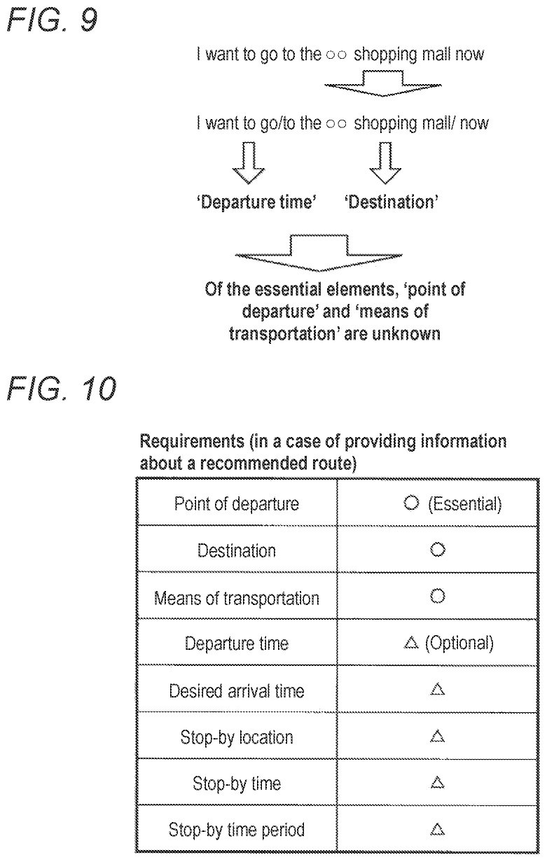

First, as shown in FIG. 9, the CPU 21 divides utterance content into phrases. For example, in an example shown in FIG. 9, the user's utterance content is “I want to go to the ∘∘ shopping mall now”, and is divided into “I want to go”, “to the ∘∘ shopping mall”, and “now”.

Then, among the divided phrases, phrases that identify requirements are extracted. Here, the requirements include a plurality of elements that are selected based on the type of information to be provided. For example, in a case of providing information about a recommended route, as shown in FIG. 10, the requirements include eight elements: ‘point of departure’, ‘destination’, ‘means of transportation’, ‘departure time’, ‘desired arrival time’, ‘stop-by location’, ‘stop-by time’, and ‘stop-by time period’. Of these elements, three elements, ‘point of departure’, ‘destination’, and ‘means of transportation’, are elements whose identification is essential to provide information about a recommended route, and the remaining five elements, ‘departure time’, ‘desired arrival time’, ‘stop-by location’, ‘stop-by time’, and ‘stop-by time period’, are elements whose identification is optional.

For example, in the utterance content shown in FIG. 9, phrases that identify requirements are two phrases: “to the ∘∘ shopping mall” that identifies the ‘destination’ and “now” that identifies the ‘departure time’. Thus, “to the ∘∘ shopping mall” and “now” are extracted. Then, at S24, it is determined based on the extracted phrases whether each element included in the requirements can be identified. Specifically, it is determined whether at least all elements whose identification is essential have been able to be identified. In a case of providing information about a recommended route, it is determined whether at least three elements, ‘point of departure’, ‘destination’, and ‘means of transportation’, have been able to be identified. For example, in the utterance content shown in FIG. 9, “the ∘∘ shopping mall” has been able to be identified as the ‘destination’, but the ‘point of departure’ and the ‘means of transportation’ have not been able to be identified. Therefore, in the example shown in FIG. 9, it is determined that the requirements cannot be identified from the text uttered by the user.

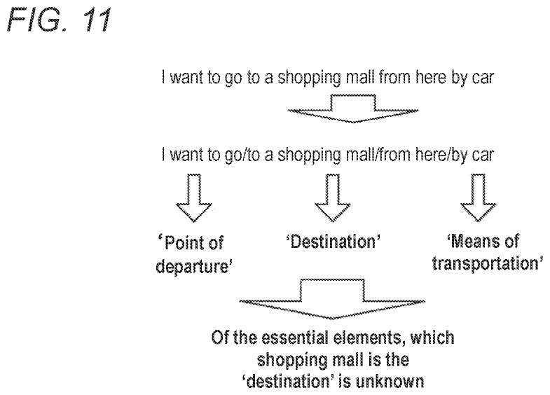

Note that at the above-described S24, even if there are phrases that identify requirements, when the identification is insufficient, it is determined that the requirements have not been able to be identified. For example, as shown in FIG. 11, when the user's utterance content is “I want to go to a shopping mall from here by car”, there are phrases that identify three elements, ‘point of departure’, ‘destination’, and ‘means of transportation’, respectively, but which shopping mall is specified cannot be identified from the “to a shopping mall”, i.e., the ‘destination’ cannot be identified, and thus, it is determined that the requirements have not been able to be identified.

Note that for the ‘point of departure’ which is one of the essential elements included in the requirements, even if there is no phrase that identifies the ‘point of departure’, it is possible to consider a user's current location as the ‘point of departure’.

Then, if it is determined, as a result of the analysis at the above-described S23, that the requirements (at least the essential elements) have not been able to be identified from the text uttered by the user (S24: NO), processing transitions to S25. On the other hand, if it is determined, as a result of the analysis at the above-described S23, that the requirements (at least the essential elements) can be identified from the text uttered by the user (S24: YES), processing transitions to S33.

Thereafter, at S25, the CPU 21 obtains a schedule registered by the user having requested information, and determines whether an essential element that has not been able to be identified from the user's utterance content can be identified from the schedule. Note that the schedule registered by the user may be obtained from the information terminal 5 or may be obtained from an external server that manages schedules. For example, when a current time or a departure time has been able to be identified, if a user's destination is registered in an event scheduled around the departure time in the schedule registered by the user, then the ‘destination’ can be identified.

Then, if it is determined that the requirements (at least the essential elements) have been able to be identified by referring to the user's schedule (S25: YES), processing transitions to S33. On the other hand, if it is determined that the requirements (at least the essential elements) have not been able to be identified even by referring to the user's schedule (S25: NO), processing transitions to S26.

At S26, the CPU 21 obtains a current state of the user having requested information. Specifically, a user location (a travel start location), whether today is a weekday or a day off, and current hours (e.g., morning, daytime, or evening) are obtained. Note that the current state of the user may be obtained from the information terminal 5, together with the information request instruction at the above-described S22.

Subsequently, at S27, the CPU 21 reads information stored in the user information DB 13. Note that the user information DB 13 is a database which is created by the above-described DB creation processing program (FIG. 5) and in which, as shown in FIG. 3, for each user, a user's past activity history item is linked with a state in which an activity in the activity history item is performed.

Then, at S28, the CPU 21 determines whether the user information DB 13 includes user's activity history items linked with the user that is an information request source having requested information and with the current state of the user obtained at the above-described S26. Note that the user that is an information request source is identified by the user ID included in the information request instruction received at the above-described S22.

Then, if it is determined that the user information DB 13 includes user's activity history items linked with the user that is an information request source having requested information and with the current state of the user (S28: YES), processing transitions to S29. On the other hand, if it is determined that the user information DB 13 does not include user's activity history items linked with the user that is an information request source having requested information and with the current state of the user (S28: NO), processing transitions to S30.

At S29, the CPU 21 complements the requirements by using the user's activity history items linked with the user that is an information request source and with the current state of the user. An object to be complemented is an element that has not been able to be identified at the present time among the elements included in the requirements.

For example, in the utterance content shown in FIG. 9, as described above, the “∘∘ shopping mall” has been able to be identified as the ‘destination’, but the ‘point of departure’ and the ‘means of transportation’ have not been able to be identified. Thus, first, user's activity history items linked with the user that is an information request source having requested information and with the current state of the user are extracted from the user information DB 13. Thereafter, of the extracted user's activity history items, user's activity history items whose travel destinations are the “∘∘ shopping mall” are further extracted. Then, a combination of a ‘travel start point’ and ‘means of transportation’ with the highest frequency in the extracted user's activity history items is selected. Then, the ‘point of departure’ and the “means of transportation” are complemented by the selected combination. For example, for user's activity history items whose travel destinations are the “∘∘ shopping mall”, when activity history items in which the user travels from his/her home by his/her car have the highest frequency, his/her home is identified as the ‘point of departure’ and his/her car is identified as the ‘means of transportation’.

On the other hand, in the utterance content shown in FIG. 11, as described above, the “user's current location” and “his/her car” have been able to be identified as the ‘point of departure’ and the ‘means of transportation’, but which shopping mall is the ‘destination’ has not been able to be identified. Therefore, first, user's activity history items linked with the user that is an information request source having requested information and with the current state of the user are extracted from the user information DB 13. Thereafter, of the extracted user's activity history items, user's activity history items in which the user travels from the user's current location (e.g., his/her home) to shopping malls (it does not matter which shopping mall is) by his/her car are further extracted. Then, a shopping mall with the highest frequency as a travel destination in the extracted user's activity history items is selected. Then, the ‘destination’ is complemented by the selected shopping mall. For example, for user's activity history items in which the user travels by his/her car from his/her home to shopping malls which are travel destinations, when activity history items in which the user travels to the “∘∘ shopping mall” have the highest frequency, the “∘∘ shopping mall” is identified as the ‘destination’. Thereafter, processing transitions to S31.

On the other hand, at S30, the CPU 21 complements the requirements by using the current state of the user obtained at the above-described S26. An object to be complemented is an element that has not been able to be identified at the present time among the elements included in the requirements.

For example, the user's current location is identified as the ‘point of departure’. In addition, when the user's current location is his/her home, his/her car is identified as the ‘means of transportation’, and when the user's current location is other than his/her home, walking is identified as the ‘means of transportation’. In addition, when, as shown in FIG. 11, which shopping mall is the ‘destination’ cannot be identified, a shopping mall located closest to the user's current location is identified as the ‘destination’. Thereafter, processing transitions to S31.

Note that at the above-described S29 and S30, of the elements included in the requirements, elements whose identification is essential are complemented, using the user information DB 13 or the current state of the user, but it is desirable to complement as many optional elements other than the essential elements as possible (e.g., ‘departure time’, ‘desired arrival time’, ‘stop-by location’, ‘stop-by time’, and ‘stop-by time period’).

Thereafter, at S31, the CPU 21 determines whether the requirements have been able to be identified as a result of complementing the requirements at the above-described S29 and S30. Specifically, it is determined whether at least all elements whose identification is essential have been able to be identified. For example, in a case of providing information about a recommended route, it is determined whether at least three elements, ‘point of departure’, ‘destination’, and ‘means of transportation’, have been able to be identified.

Then, if it is determined that the requirements (at least the essential elements) have been able to be identified as a result of complementing the requirements at the above-described S29 and S30 (S31: YES), processing transitions to S33. On the other hand, if it is determined that the requirements (at least the essential elements) have not been able to be identified even after complementing the requirements at the above-described S29 and S30 (S31: NO), processing transitions to S32.

At S32, the CPU 21 performs an inquiry process. Specifically, an inquiry for clarifying an element that has not been able to be identified among the requirements is outputted through the information terminal 5. For example, when, for the ‘destination’, one candidate cannot be identified from a plurality of candidates, a list of a plurality of destinations serving as candidates is displayed on the display 38 to allow the user to make a selection. In addition, when the ‘means of transportation’ cannot be identified, a list of means of transportation is displayed on the display 38 to allow the user to make a selection. The inquiry process is repeatedly performed until all elements whose identification is essential among the elements included in the requirements have been able to be identified. Thereafter, processing transitions to S33.

At S33, the CPU 21 searches for a recommended route based on the finally identified requirements. In addition, the recommended route search uses a publicly known Dijkstra's algorithm, and a route with the smallest total cost value is determined to be a recommended route. In a case of providing information about a recommended route, the requirements include eight elements: ‘point of departure’, ‘destination’, ‘means of transportation’, ‘departure time’, ‘desired arrival time’, ‘stop-by location’, ‘stop-by time’, and ‘stop-by time period’. Of the eight elements, identified elements are used as search conditions and a recommended route search is performed. Note that in the recommended route search, cost computation based on means of transportation is performed. For example, when the means of transportation is a user's car, the cost values of wide roads such as national highways and prefectural highways are reduced, and when the means of transportation is walking, the cost values of roads with sidewalks are reduced.

Thereafter, at S34, the CPU 21 delivers information about the recommended route searched at the above-described S33 to the information terminal 5 which is the request source. Thereafter, the information delivered to the information terminal 5 is outputted (S14).

Note that the configuration may be such that instead of the server device 3, the information terminal 5 performs the processes at the above-described S22 to S33. In that case, the information terminal 5 is configured to include the user history DB 12 and the user information DB 13. In addition, the information terminal 5 may also be configured to execute the DB creation processing program (FIG. 5).

As described in detail above, the information provision system 1 and the server device 3 according to the present embodiment determine whether requirements which are items required to identify information requested by a user can be identified from text uttered by the user, by analyzing the text uttered by the user (S24), complement the requirements using user information stored in the user information DB 13 when the requirements cannot be identified from the text uttered by the user (S29), and provide information responding to a user request, based on the complemented requirements (S33 and S34). Thus, it becomes possible to provide information that the user wants even when content uttered by the user is lacking or unclear.

Note that the present invention is not limited to the above-described embodiment and it is, of course, possible to make various modifications and alterations thereto without departing from the spirit and scope of the present invention.

For example, although, in the present embodiment, one server device 3 performs each of a process of creating DBs including the user history DB 12 and the user information DB 13 and a process of providing information, different server devices may perform the process of creating DBs and the process of providing information. For example, the server device 3 may receive DBs created by another server device and provide information.

In addition, although, in the present embodiment, an object to be provided by the information provision system 1 is information about a recommended route to a destination, it is also possible that an object to be provided is other information. Objects to be provided may be, for example, location information about locations (facilities) across the country and traffic information (whether there is congestion, an accident, or construction work, etc.) on each road across the country. Note that when information that is an object to be provided is different, elements included in requirements are also different. For example, in a case of providing location information about a location, the requirements include elements such as ‘location name’, ‘genre of the location’, ‘area where the location is present’, ‘type of information requested’, and ‘whether there is a request for a route’. Of these elements, at least either one of the ‘location name’ and ‘genre of the location’ and the element ‘type of information requested’ are elements whose identification is essential to provide location information about the location, and the other elements are elements whose identification is optional.

In addition, although, in the present embodiment, content uttered by the user is inputted as text instructing for an information request, particularly, by analyzing speech uttered by the user by speech recognition, the input of text instructing for an information request may be performed by other methods than the above-described speech recognition. For example, the input of text instructing for an information request may be performed by the user performing a character input operation (characters may be specified or handwriting input may be performed) using a keyboard, a touch panel, etc.

In addition, although, in the present embodiment, a subject that executes the DB creation processing program shown in FIG. 5 is the server device 3, the information terminal 5 may be configured to execute part or the entire program. In addition, although an example in which the information terminal 5 is applied to a smartphone is described, it is also possible to apply the information terminal 5 to other types of information terminals as long as the terminals have an information providing function. For example, it is possible to apply the information terminal 5 to a mobile phone, a tablet terminal, a personal computer, a navigation device, etc.

In addition, although an implementation example in which the information provision system according to the present invention is embodied is described above, the information provision system can also have the following configurations, and in that case, the following advantageous effects are provided.

For example, a first configuration is as follows:

An information provision system includes: user information obtaining means (21) for obtaining user information about a user (4); requirement determining means (21) for determining whether requirements can be identified from text inputted by a user, by analyzing text inputted by a user, the requirements being items required to identify information requested by a user; complementing means (21) for complementing the requirements using the user information when the requirements cannot be identified from text inputted by a user; and information providing means (21) for providing information responding to a user request, based on the complemented requirements.

According to the information provision system having the above-described configuration, when requirements which are items required to identify information requested by the user cannot be identified from text inputted by the user, the requirements are complemented based on user information, by which it becomes possible to provide information that the user wants even when user's input content is lacking or unclear.

In addition, a second configuration is as follows:

The requirements include a plurality of elements selected based on a type of information to be provided.

According to the information provision system having the above-described configuration, by setting requirements including elements that are selected based on the type of information to be provided, it becomes possible to complement required elements that are selected based on the type of information to be provided. As a result, even in a case of providing a plurality of types of information, it becomes possible to provide information that the user wants.

In addition, a third configuration is as follows:

The requirement determining means (21) determines, for each of a plurality of elements selected based on a type of information to be provided, whether the element can be identified from text inputted by a user, and the complementing means (21) complements an element that cannot be identified from text inputted by a user, using the user information.

According to the information provision system having the above-described configuration, of elements included in requirements that are set based on the type of information to be provided, particularly, an element that cannot be identified from text inputted by the user is to be complemented based on user information. As a result, even in a case of providing a plurality of types of information, it becomes possible to provide information that the user wants.

In addition, a fourth configuration is as follows:

The user information includes information in which a user's past activity history item is linked with a state in which a user activity is performed, and the complementing means (21) complements the requirements using a history item of a user activity performed in a state corresponding to a current state, when the requirements cannot be identified from text inputted by a user.

According to the information provision system having the above-described configuration, by predicting information that the user wants, based on a user's past activity history, it becomes possible to provide information that the user wants even when user's input content is lacking or unclear.

In addition, a fifth configuration is as follows:

At least one or more of a user's travel history, a user's destination setting history, means of transportation used by a user to travel, states in which a user has traveled, and content of a registered user's schedule is collected, and the user information is generated based on collected information.

According to the information provision system having the above-described configuration, by collecting user's past activity history items and compiling statistics on the collected activity history items, it becomes possible to predict information that the user wants.

In addition, a sixth configuration is as follows:

The user information includes information about a schedule registered by a user, and the complementing means (12) complements the requirements using the schedule when the requirements cannot be identified from text inputted by a user.

According to the information provision system having the above-described configuration, by predicting information that the user wants, based on a schedule registered by the user, it becomes possible to provide information that the user wants even when user's input content is lacking or unclear.

In addition, a seventh configuration is as follows:

The text inputted by the user is text that is inputted by recognizing speech uttered by a user and that indicates content uttered by a user.

According to the information provision system having the above-described configuration, when requirements which are items required to identify information that the user wants cannot be identified from text uttered by the user, the requirements are complemented based on user information, by which it becomes possible to provide information that the user wants even when user's utterance content is lacking or unclear.

### REFERENCE SIGNS LIST

1: Information provision system, 2: Probe center, 3: Server device, 4: Vehicle, 5: Navigation device, 11: Server control ECU, 12: User history DB, 13: User information DB, 21: CPU, 22: RAM, and 23: ROM

1. An information provision system comprising:
user information obtaining means for obtaining user information about a user;
requirement determining means for determining whether requirements can be identified from text inputted by a user, by analyzing text inputted by a user, the requirements being items required to identify information requested by a user;
complementing means for complementing the requirements using the user information when the requirements cannot be identified from text inputted by a user; and
information providing means for providing information responding to a user request, based on the complemented requirements.

2. The information provision system according to claim 1, wherein the requirements include a plurality of elements selected based on a type of information to be provided.

3. The information provision system according to claim 2, wherein
the requirement determining means determines, for each of a plurality of elements selected based on a type of information to be provided, whether the element can be identified from text inputted by a user, and
the complementing means complements an element that cannot be identified from text inputted by a user, using the user information.

4. The information provision system according to claim 1, wherein
the user information includes information in which a user's past activity history item is linked with a state in which a user activity is performed, and
the complementing means complements the requirements using a history of user activities performed in a state corresponding to a current state, when the requirements cannot be identified from text inputted by a user.

5. The information provision system according to claim 4, wherein
at least one or more of a user's travel history, a user's destination setting history, means of transportation used by a user to travel, states in which a user has traveled, and content of a registered user's schedule is collected, and
the user information is generated based on collected information.

6. The information provision system according to claim 1, wherein
the user information includes information about a schedule registered by a user, and
the complementing means complements the requirements using the schedule when the requirements cannot be identified from text inputted by a user.

7. The information provision system according to claim 1, wherein the text inputted by the user is text that is inputted by recognizing speech uttered by a user and that indicates content uttered by a user.

8. An information provision device comprising:
user information obtaining means for obtaining user information about a user;
requirement determining means for determining whether requirements can be identified from text inputted by a user, by analyzing text inputted by a user, the requirements being items required to identify information requested by a user;
complementing means for complementing the requirements using the user information when the requirements cannot be identified from text inputted by a user; and
information providing means for providing information responding to a user request, based on the complemented requirements.

9. A computer program causing a computer to function as:
user information obtaining means for obtaining user information about a user;
requirement determining means for determining whether requirements can be identified from text inputted by a user, by analyzing text inputted by a user, the requirements being items required to identify information requested by a user;
complementing means for complementing the requirements using the user information when the requirements cannot be identified from text inputted by a user; and
information providing means for providing information responding to a user request, based on the complemented requirements.
